(19) United States
(12) Patent Application Publication
(10) Pub. No.: US 2014/0253260 A1
(43) Pub. Date: Sep. 11, 2014

(54) HIGH-FREQUENCY SWITCH

(71) Applicants: Yasuhiro Horimoto, Shiga (JP); Takahiro Masuda, Kyoto (JP); Daisuke Morihara, Shiga (JP)

(72) Inventors: Yasuhiro Horimoto, Shiga (JP); Takahiro Masuda, Kyoto (JP); Daisuke Morihara, Shiga (JP)

(73) Assignee: OMRON CORPORATION, Kyoto-shi (JP)

(21) Appl. No.: 14/051,057

(22) Filed: Oct. 10, 2013

(30) Foreign Application Priority Data
Mar. 8, 2013 (JP) 2013-046709

(51) Int. Cl. H01P 1/10

(52) U.S. Cl. CPC H04L 25/0272
USPC 333/105

(57) ABSTRACT

A high-frequency switch configured to transmit differential signals including first and second signals, has first and second switches each comprising an input terminal configured to receive a signal and two output terminals configured to output the signal, and a substrate comprising a first surface mounted with the first and second switches. The input terminal is arranged between the two output terminals. The first and second switches are arranged on the substrate along a direction intersecting with a direction in which the input terminal and the two output terminals are placed side by side. One terminal of the first switch and one terminal of the second switch are placed side by side along the direction in which the first and second switches are arranged.

### CROSS REFERENCE TO RELATED APPLICATIONS

This application claims priority to Japanese Patent Application No. 2013-046709 filed on Mar. 8, 2013, the entire contents of which are incorporated by reference herein

### BACKGROUND

1. Technical Field

The present invention relates to a high-frequency switch, and especially relates a high frequency switch suitable for differential transmission.

2. Related Art

A high-frequency switch is used, for example, for switching a channel of high-frequency signals, or switching transmission and cutoff of signals. For example, U.S. Pat. No. 6,809,255 (Patent Document 1) discloses a high-frequency relay having a ground shield. For example, Japanese Unexamined Patent Publication No. 2000-113792 (Patent Document 2) discloses an electrostatic micro relay. In this electrostatic micro relay, fixed electrodes are provided on both sides of a signal line at an equal distance. Further, the fixed electrodes are simultaneously used with a high-frequency GND (ground) electrode.

In recent years, differential transmission has been adopted to transmission of digital signals. Generally, in the differential transmission, two signals with a phase difference of 180° are transmitted to a pair of signal lines. The differential transmission can make an amplitude of a voltage smaller as compared to single transmission. Therefore, the differential transmission has advantages of high data transmission speed and high noise resistance.

When the differential transmission is adopted for transmission of high-frequency signals, the high-frequency switch is required to have a configuration suitable for differential signals. However, neither U.S. Pat. No. 6,809,255 nor Unexamined Japanese Patent Publication No. 2000-113792 specifically discloses the configuration of the high-frequency switch which is suitable for differential transmission.

### SUMMARY

One or more embodiments of the present invention provides a high-frequency switch suitable for differential transmission.

According to one or more embodiments of the present invention, a high-frequency switch configured to transmit differential signals including first and second signals is provided with: first and second switches each having an input terminal configured to receive a signal and two output terminals configured to output the signal; and a substrate having a first surface mounted with the first and second switches. The input terminal is arranged between the two output terminals. The first and second switches are arranged on the substrate along a direction intersecting with a direction in which the input terminal and the two output terminals are placed side by side. One terminal of the first switch and one terminal of the second switch are placed side by side along the direction in which the first and second switches are arranged. The other terminal of the first switch and the other terminal of the second switch are placed side by side along the direction in which the first and second switches are arranged.

According to this configuration, the signal line connected to the one terminal of the first switch and the signal line connected to the one terminal of the second switch can be made to have equal lengths. Further, the two signal lines can also be arranged as close to each other as possible. Differential signals can be transmitted by the two signal lines. The signal line connected to the other terminal of the first switch and the signal line connected to the other terminal of the second switch can also be made to have equal lengths, and the two signal lines can also transmit differential signals since they can be brought as close to each other as possible. Therefore, according to this configuration, it is possible to realize a high-frequency switch suitable for differential signals.

Further, according to the above configuration, it is possible to perform wiring with ease, so as to increase an effective package density. A mounting area of the switch also includes signal lines necessary for effective input into and output from the switch. Simplification of the wiring can lead to reduction in mounting area of the switch, thereby to increase in effective package density of the substrate.

According to one or more embodiments of the present invention, the substrate includes first and second input signal lines respectively connected to the input terminal of the first switch and the input terminal of the second switch, first and second output signal lines respectively connected to one terminal of the two output terminals of the first switch and one terminal of the two output terminals of the second switch, and third and fourth output signal lines respectively connected to the other terminal of the two output terminals of the first switch and the other terminal of the two output terminals of the second switch. The first and second input signal lines constitute a first signal line pair configured to transmit the differential signals. The first and second output signal lines constitute a second signal line pair configured to transmit the differential signals. The third and fourth output signal lines constitute a third signal line pair configured to transmit the differential signals. Each of the first, second or third signal line pairs has at least one of rotational symmetry, mirror symmetry and translational symmetry.

According to this configuration, it is possible to make transmission quality of the differential signals favorable. When the signal line is in a uniform shape, the signal is not reflected. However, reflection occurs in a section of the signal line where a sectional shape thereof changes, such as a bent section or a section where a line width changes. It is assumed, for example, that each of the two signal lines constituting the signal line pair has two reflection points. When a distance between the two reflection points differs between the two signal lines constituting the signal line pair, waveforms of the signals that have repeated reflection differ from each other. For this reason, when a difference between the signals respectively transmitted on the two signal lines is taken, loss is generated. In this configuration, symmetry exists between the two signal lines.

According to one or more embodiments of the present invention, the first signal line pair includes first wiring portions arranged with twofold rotational symmetry, and second wiring portions arranged with mirror symmetry with respect to the direction in which the first and second switches are arranged.

According to this configuration, the first signal line pair has rotational symmetry wiring portions (first wiring portions) and mirror symmetry portions (second wiring portions). When the first and second switches are arranged at different distances from an input port, a signal line pair having equal lengths and high symmetry can be realized by the rotational symmetry wiring portions. Accordingly, it is possible to reduce loss attributed to mode transition in transmission of differential signals. Further, a distance between a pad pair arranged on the second surface of the substrate and corresponding to the signal line pair can be arbitrarily set by the mirror symmetry portions. According to one or more embodiments of the present invention, the first signal line pair further includes third wiring portions arranged with translational symmetry with respect to the direction in which the input terminal and the two output terminals are placed side by side.

According to this configuration, the first signal line pair further has translational symmetry wiring portions (third wiring portions). It is thereby possible to arbitrarily set a position of the pad pair arranged on the second surface of the substrate and corresponding to the signal line pair.

According to one or more embodiments of the present invention, each of the second and third signal line pairs is arranged so as to satisfy at least one of mirror symmetry with respect to the direction in which the input terminal and the two output terminals are placed side by side and translational symmetry with respect to the direction in which the first and second switches are arranged.

According to this configuration, each of the second and third signal line pairs has mirror symmetry portions and/or translational symmetry portions. By having the mirror symmetry portions, each of the second and third signal line pairs can arbitrarily set a distance between the pad pair arranged on the second surface of the substrate and corresponding to the signal line pair. Further, by having the translational symmetry wiring portions, each of the second and third signal line pairs can arbitrarily set a position of the pad pair arranged on the second surface of the substrate and corresponding to the signal line pair.

The high-frequency switch further includes a sealing member arranged on the first surface of the substrate and configured to seal the first and second switches. The substrate includes a second surface located on the opposite side to the first surface, first and second input pads arranged adjacent to each other on the second surface and electrically connected respectively to the first and second input signal lines, first and second output pads arranged adjacent to each other on the second surface and electrically connected respectively to the first and second output signal lines, and third and fourth output pads arranged adjacent to each other on the second surface and electrically connected respectively to the third and fourth output signal lines.

According to this configuration, components mounted on the first surface of the substrate (the components include the first and second switches; another component may be mounted on the first surface in addition to the first and second switches) can be protected by the sealing member from the outside, so as to enhance the reliability of the high-frequency switch. On the other hand, with the sealing member being arranged on the first surface of the substrate, the input pad and the output pad are arranged on the second surface located on the opposite side to the first surface. By arranging the first and second input signal lines as close to each other as possible on the first surface, the two input pads can be arranged close to each other on the second surface. In the same manner, by arranging the first and second output signal lines as close to each other as possible on the first surface, the two output pads can be arranged as close to each other.

According to one or more embodiments of the present invention, the first and second switches are MEMS (Micro Electro Mechanical Systems) switches.

According to this configuration, it is possible to achieve improvement in yield rate. A DPDT (Double Pole Double Throw) switch is configured by the first and second switches. When the DPDT switch is formed on a wafer level, a yield rate is the probability that four contacts are all judged as good. As opposed to this, in the above configuration, since the DPDT switch is configured by combination of the first and second switches, a yield rate of the first or second switch (probability that two contacts are all judged as good) almost agrees with the yield rate of the DPDT switch. The probability that two contacts are all judged as good is high as compared to the probability that four contacts are all judged as good. It is thus possible to achieve improvement in yield rate.

According to one or more embodiments of the present invention, the MEMS switch be an electrostatic drive type MEMS switch.

According to this configuration, it is possible to reduce consumption power of the high-frequency switch. It is further possible to enhance a response speed of the high-frequency switch.

According to one or more embodiments of the present invention, the two output terminals of each of the first and second switches be arranged with symmetry with respect to the input terminal.

According to this configuration, it is possible to realize a layout with high symmetry in the case of arranging signal lines on the substrate surface. Hence it is possible to facilitate wiring of the first and second switches.

According to one or more embodiments of the present invention, the high-frequency switch further includes at least one of a passive element and an active element mounted on the first surface of the substrate along with the first and second switches.

According to this configuration, it is possible to enhance a function or performance of the high-frequency switch. For example, the first and second switches can be controlled (e.g., voltages can be supplied to the first and second switches) by the active element. This may eliminate the need for preparing additional configuration (e.g., voltage supply source) for the high-frequency switch. Further, a filter can be formed by the passive element, for example, so as to facilitate adjustment of characteristics.

According to one or more embodiments of the present invention, it is possible to realize a high-frequency switch suitable for differential transmission.

### BRIEF DESCRIPTION OF THE DRAWINGS

FIG. 1 is a view explaining an SPDT switch and a DPDT switch;

FIG. 2 is a view showing a basic configuration of a high-frequency switch according to one or more embodiments of the present invention;

FIG. 3 is a perspective view showing one embodiment of the SPDT switch shown in FIG. 2;

FIG. 4 is an exploded perspective view of the SPDT switch shown in FIG. 3;

FIG. 5 is a top view of the SPDT switch shown in FIG. 3, from which external electrodes and through wires have been omitted;

FIG. 6 is a perspective view showing one embodiment of the SPDT switch shown in FIG. 2;

FIG. 7 is a perspective view showing one embodiment of the SPOT switch shown in FIG. 6;

FIG. 8 is a plan view schematically showing an SPDT switch constituting two SPST switches shown in FIGS. 6 and 7;

FIG. 9 is a view schematically showing a cross section of the SPDT switch shown in FIGS. 6 to 8;

FIG. 10 is a view showing coordinates of the input terminal and the two output terminals of the SPDT switch;

FIG. 11 is a view for explaining coordinates of the SPDT switch with an origin of the principal surface of the substrate taken as a reference;

FIG. 12 is a view for explaining coordinates of the two SPDT switches arranged on the principal surface of the substrate;

FIG. 13 is a view showing one embodiment of a signal line pattern formed on the substrate;

FIG. 14 is a view for explaining symmetry of input signal lines;

FIG. 15 is a view for explaining, in detail, rotational symmetry portions of an input signal line pair shown in FIG. 14;

FIG. 16 is a view for explaining symmetry of an output signal line pair shown in FIG. 14;

FIG. 17 is a view for explaining symmetry of the other output signal line pair shown in FIG. 14;

FIG. 18 is a view showing an example of a wiring pattern in the state where respective two signal lines constituting the signal line pairs are extracted along the surface in the shortest manner;

FIG. 19 is a view showing another example of wiring according to one or more embodiments of the present invention;

FIG. 20 is an internal perspective view of a high-frequency switch according to Embodiment 1;

FIG. 21 is a view showing arrangement of pads on the lower surface of the substrate;

FIG. 22 is a view for explaining arrangement of the two SPDT switches on the substrate;

FIG. 23 is a view for explaining arrangement of the signal line pairs;

FIG. 24 is an internal perspective view of a high-frequency switch according to Embodiment 2; and

FIG. 25 is a plan transparent view for explaining a signal line formed on a substrate shown in FIG. 24.

### DETAILED DESCRIPTION

In the following, embodiments of the present invention will be described in detail while referring to the drawings. It is to be noted that identical or corresponding portions in the drawings are provided with the same numeral and a description thereof is not repeated. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In this specification, a term “n-fold rotational symmetry” (n is an integer) indicates such a nature as to overlap oneself when being rotated around a certain point (or axis) at (360/n)°. As long as no specific mention is made, the “rotational symmetry” means “twofold rotational symmetry”.

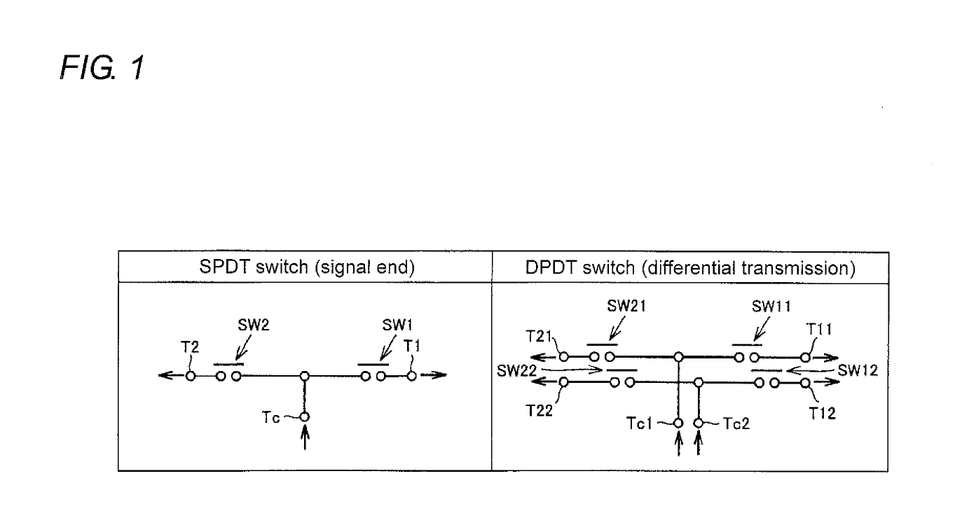

According to one or more embodiments of the invention, a DPDT (Double Pole Double Throw) switch is configured of two SPDT (Single Pole Double Throw) switches. FIG. 1 is a view explaining the SPDT switch and the DPDT switch.

Referring to FIG. 1, the SPOT switch has one input terminal Tc, two contacts SW1, SW2, and two output terminals T1, T2 respectively connected to the two contacts SW1, SW2. A signal inputted into the input terminal Tc is divided and outputted from the output terminals T1, T2. The DPDT switch is provided with input terminals Tc1, Tc2, contacts SW11, SW21, SW12, SW22, and output terminals T11, T12, T21, T22. The output terminals T11, T21 are respectively connected to the contacts SW11, SW21. A signal inputted into the input terminal Tc1 is divided and outputted from the output terminals T11, T21. Similarly, the signal inputted into the input terminal Tc2 is divided and outputted from the output terminals T12, T22. It can be understood from FIG. 1 that the DPDT switch can be used for differential transmission. Specifically, two signals with a phase difference of 180° are respectively inputted into the input terminals Tc1, Tc2. Two signals with a phase difference of 180° are respectively outputted from the output terminals T11, T12. In the same manner, two signals with a phase difference of 180° are respectively outputted from the output terminals T21, T22. That is, upon receipt of differential signals, the DPDT switch divides the differential signals into two channels.

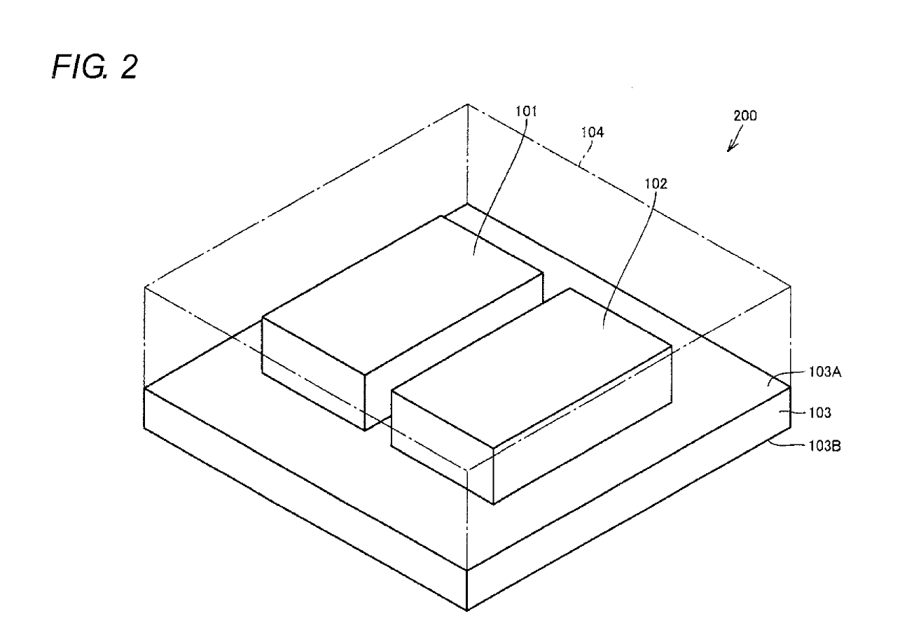

FIG. 2 is a view showing a basic configuration of a high-frequency switch according to one or more embodiments of the present invention. Referring to FIG. 2, a high-frequency switch 200 according to one or more embodiments of the present invention is provided with SPDT switches 101, 102, a substrate 103, and a sealing member 104.

The substrate 103 has principal surfaces 103A, 103B. The SPDT switches 101, 102 are mounted on the principal surface 103A of the substrate 103. As described later, the substrate 103 is formed with wires (signal line pairs) electrically connected to the SPDT switches 101, 102. Further, pads are formed on the principal surface 103B of the substrate 103 for electric connection with other circuit components, not shown. The substrate 103 has through wires electrically connecting the electrodes on the principal surface 103A and the pads on the principal surface 103B. The substrate 103 is either a double-sided substrate or a multi-layer substrate.

The sealing member 104 is arranged on the principal surface 103A of the substrate 103, and seals the SPDT switches 101, 102.

In one embodiment, the SPDT switches 101, 102 are realized by MEMS (Micro Electro Mechanical Systems) switches. The SPDT switches 101, 102 have identical configurations. Hereinafter, the SPDT switch 101 will be representatively described.

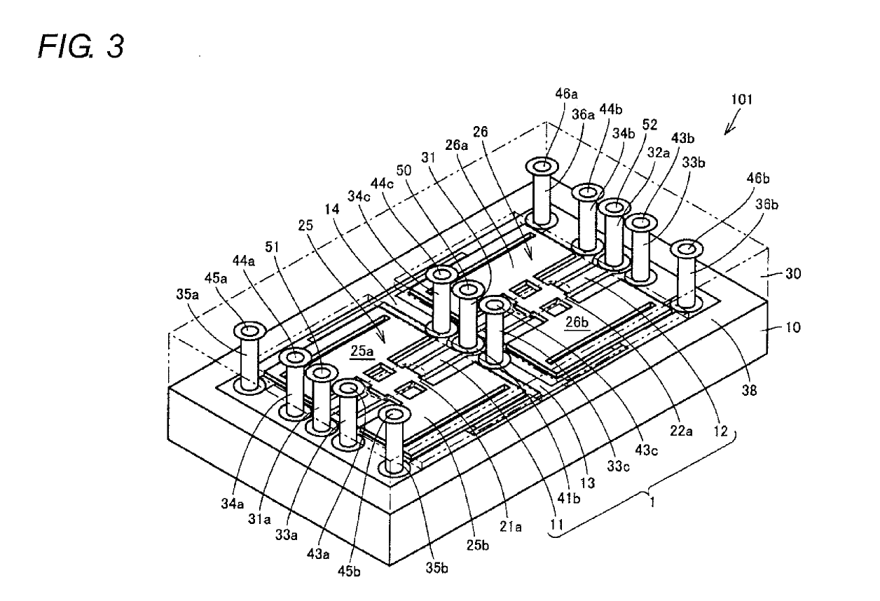

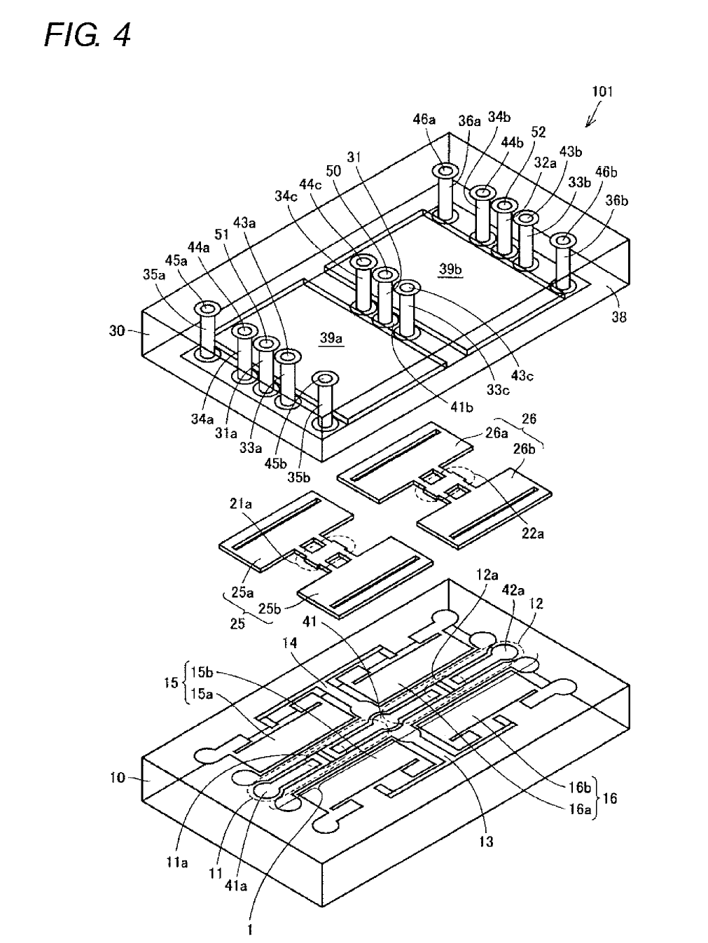

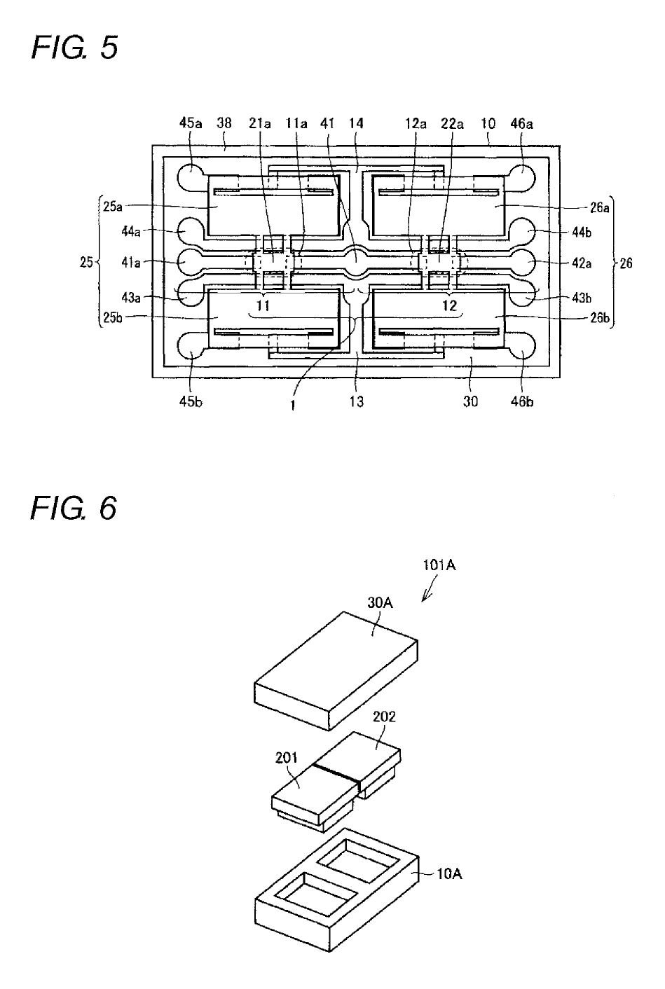

FIG. 3 is a perspective view showing one embodiment of the SPOT switch 101 shown in FIG. 2. FIG. 4 is an exploded perspective view of the SPDT switch 101 shown in FIG. 3. FIG. 5 is a top view of the SPDT switch 101 shown in FIG. 3, from which the external electrodes and the through wires have been omitted. Referring to FIGS. 3 to 5, the SPDT switch 101 has a substrate 10, a signal line 1, ground electrodes 13, 14, and fixed electrodes 15, 16. The substrate 10 is, for example, a glass substrate. The signal line 1, the ground electrodes 13, 14 and the fixed electrodes 15, 16 are arranged on one surface of the substrate 10.

The signal line 1 includes a pad 41 and signal lines 11, 12. The pad 41 corresponds to an input point of the signal. The signal lines 11, 12 correspond to two signal channels arranged so as to form one straight line. The signal lines 11, 12 respectively have fixed contacts 11a, 12a. In other words, the signal line 1 is divided into two signal lines (signal lines 11, 12) with the pad 41 as the center.

The ground electrode 13 is arranged on one side with respect to the signal line 1 on the surface of the substrate 10. The ground electrode 14 is arranged on the other side to the ground electrode 13 on the surface of the substrate 10. In other words, the signal line 1 is arranged between the ground electrodes 13 and 14. That is, in this embodiment, the signal line 1 constitutes a coplanar waveguide along with the ground electrodes 13, 14.

The fixed electrodes 15, 16 each have two electrodes arranged so as to sandwich the coplanar waveguide. Specifically, the fixed electrode 15 includes electrodes 15a, 15b. The fixed electrode 16 includes electrodes 16a, 16b.

The SPDT switch 101 further includes movable contacts 21a, 22a and actuators 25, 26. The actuators 25, 26 are, for example, formed of silicon. The movable contacts 21a, 22a are metal films formed on an insulating film (e.g., silicon oxide film) which is, for example, formed on the actuators 25, 26.

Each of the actuators 25, 26 is a movable electrode. The actuator 25 makes the movable contact 21a brought into contact with and separated from the fixed contact 11a. The actuator 26 makes the movable contact 22a brought into contact with and separated from the fixed contact 12a.

Each of the actuators 25, 26 has a double-supported beam structure for supporting the movable contact. Specifically, the actuator 25 has electrodes 25a, 25b. The movable contact 21a is connected between the electrodes 25a and 25b. The actuator 26 has electrodes 26a, 26b. The movable contact 22a is connected between the electrodes 26a and 26b.

In this embodiment, the signal line 1 (signal lines 11, 12 and pad 41) is formed such that the length of the signal line 11 from the pad 41 to the fixed contact 11a is equal to the length of the signal line 12 from the pad 41 to the fixed contact 12a.

The length of the signal line 11 from the input point to the fixed contact 11a and the length of the signal line 12 from the input point to the fixed contact 12a are set so as to be the shortest distance. In one embodiment, this shortest distance is the shortest distance defined by arrangement of the actuators 25, 26. Specifically, positions of the movable contacts 21a, 22a are determined by arranging the actuators 25, 26 in accordance with the minimum space between the actuators 25 and 26. A median point of a line segment connecting the movable contact 21a and the movable contact 22a corresponds to the input point of the signal. The minimum space between the actuators 25 and 26 can be set, for example, in accordance with a process rule applied in a process for manufacturing the SPDT switch 101.

When the positions of the movable contacts 21a, 22a are determined, positions of the fixed contacts 11a, 12a are necessarily determined. By minimizing the space between the actuators 25 and 26, the length of the signal line 11 from the input point to the fixed contact 11a and the length of the signal line 12 from the input point to the fixed contact 12a can be set to the shortest distance.

The SPDT switch 101 further includes a cap 30. A material for the cap 30 is, for example, glass. The cap 30 is bonded with the substrate 10 through a sealing material 38 such as glass frit. The cap 30 is formed with cavities 39a, 39b as spaces for respectively housing the actuators 25, 26.

The cap 30 is formed with through wires 31, 31a, 32a, 33a, 33b, 33c, 34a, 34b, 34c, 35a, 35b, 36a, 36b. One side-surface of the cap 30 is formed with external electrodes 50, 51a, 52a, 43a, 43b, 43c, 44a, 44b, 44c, 45a, 45b, 46a, 46b. The external electrodes 50, 51a, 52a, 43a, 43b, 43c, 44a, 44b, 44c, 45a, 45b, 46a, 46b are electrically connected respectively to the through wires 31, 31a, 32a, 33a, 33b, 33c, 34a, 34b, 34c, 35a, 35b, 36a, 36b.

The other side-surface of the cap 30, namely the opposed surface to the substrate 10, is formed with internal electrodes electrically connected respectively to the through wires 31, 31a, 32a, 33a, 33b, 33c, 34a, 34b, 34c, 35a, 35b, 36a, 36b. These internal electrodes are electrically connected to the pads of the respective electrodes formed on the surface of the substrate 10. FIG. 4 representatively show pads 41, 41a, 42a respectively connected to the through wires 31, 31a, 32a.

The through wire 31 is electrically connected to the pad 41 through the internal electrode 41b. The through wire 31 is a signal input portion that receives a signal through the external electrode 50. The external electrode 50, the through wire 31 and the pad 41 constitute the input terminal that receives a high-frequency signal.

The through wire 31a is electrically connected to the pad 41a through the internal electrode. The through wire 32a is electrically connected to the pad 42a through the internal electrode. The external electrode 51, the through wire 31a, the internal electrode and the pad 41a constitute one terminal that outputs the high-frequency signal. The external electrode 52, the through wire 32a, the internal electrode and the pad 42a constitute the other terminal that outputs the high-frequency signal.

The through wires 33a, 33b, 33c are electrically connected to the ground electrode 13. Similarly, the through wires 34a, 34b, 34c are electrically connected to the ground electrode 14. The through wires 33a, 33b, 33c, 34a, 34b, 34c are wires for providing a ground voltage from the outside of the SPDT switch 101 to the ground electrode 13 or the ground electrode 14.

The through wires 35a, 35b are electrically connected respectively to the electrodes 15a, 15b of the fixed electrode 15. Similarly, the through wires 36a, 36b are electrically connected respectively to the electrodes 16a, 16b of the fixed electrode 16. The through wires 35a, 35b, 36a, 36b are wires for providing a voltage from the outside of the SPDT switch 101 to the fixed electrode 15 or the fixed electrode 16.

The sealing material 38 is arranged so as to surround a plurality of through wires. The cavities 39a, 39b are held in an airtight state by the sealing material 38. By such a structure, it is possible to prevent entry of dust, moisture or the like into the cavities 39a, 39b from the outside of the SPOT switch 101.

It should be noted that the SPDT switches 101, 102 are flip-chip mounted on the substrate 103. That is, the external electrodes of the SPDT switches 101, 102 are electrically connected to the electrodes formed on the principal surface 103A of the substrate 103 (cf. FIG. 2).

FIGS. 3 to 5 show the integrally formed SPDT switch. As opposed to this, in another embodiment, an SPDT switch is configured by combining two SPST (Single Pole Single Throw) switches.

FIG. 6 is a perspective view showing one embodiment of the SPDT switch shown in FIG. 2. Referring to FIG. 6, an SPDT switch 101A is provided with SPST switches 201, 202, a package 10A made, for example, of ceramic, and a sealing member 30A. The package 10A is formed with spaces for housing the SPST switches 201, 202. The SPST switches 201, 202 are flip-chip mounted on the package 10A.

The SPST switches 201, 202 are realized by the MEMS switches. The SPST switches 201, 202 have identical configurations. Hereinafter, the SPST switch 201 will be representatively described.

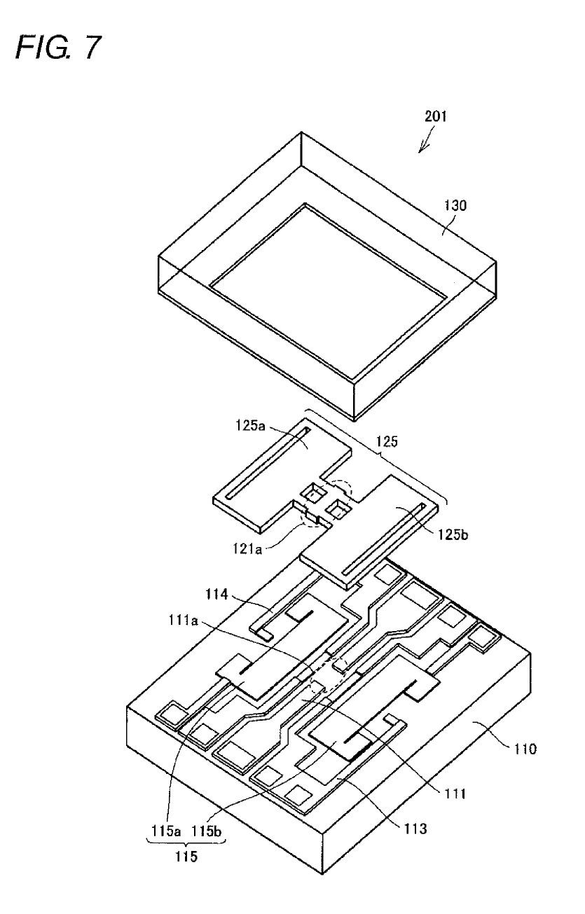

FIG. 7 is a perspective view showing one embodiment of the SPST switch 201 shown in FIG. 6. Referring to FIG. 7, the SPST switch 201 includes a substrate 110, a signal line 111, ground electrodes 113, 114, a fixed electrode 115, an actuator 125, and a cap 130. The signal line 111, the ground electrodes 113, 114 and the fixed electrode 115 are arranged on one surface of the substrate 110. The signal line 111 has a fixed contact 111a. The ground electrodes 113, 114 constitute a coplanar waveguide along with the signal line 111.

The fixed electrode 115 includes electrodes 115a, 115b. The actuator 125 includes electrodes 125a, 125b. The movable contact 121a is connected between the electrodes 125a and 125b. The cap 130 is bonded to the substrate 110. The cap 130 is formed with a space for housing the actuator 125.

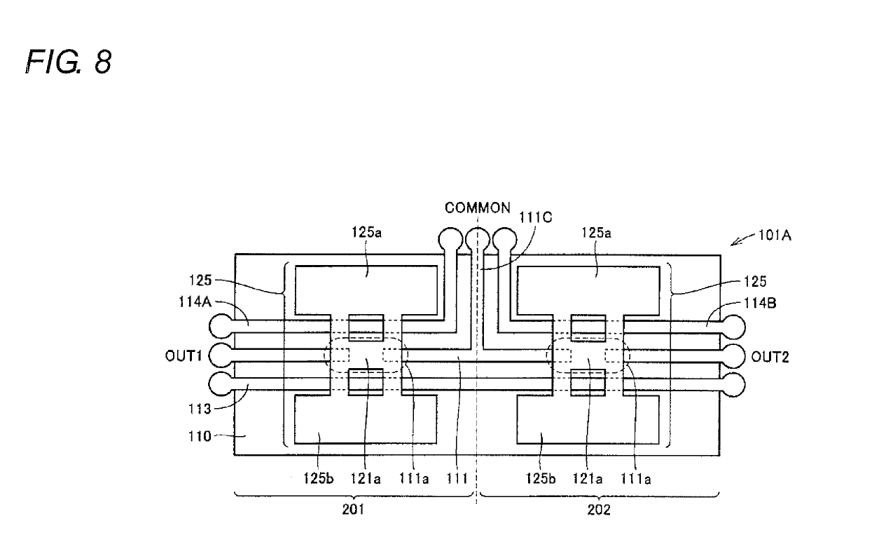

FIG. 8 is a plan view schematically showing the SPDT switch 101A constituting the two SPST switches 201, 202 shown in FIGS. 6 and 7. Referring to FIG. 8, a signal line 111C is extracted from a median point of the signal line 111 to a periphery of the SPDT switch 101A along the surface of the substrate 10.

A pad (COMMON) for receiving a signal is formed on the wire extracted from the center of the signal line. Two pads (OUT1, OUT2) for outputting the signal are arranged on the right side and the left side of the pad for receiving the signal. As thus described, also in the configurations shown in FIGS. 6 to 8, the input terminal (COMMON) of the SPDT switch is arranged between the two output terminals (OUT1, OUT2).

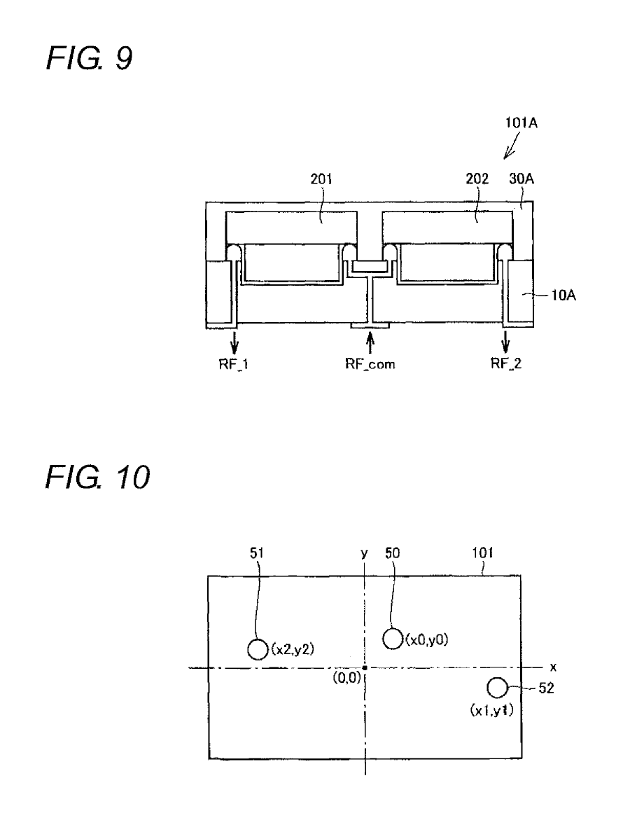

FIG. 9 is a view schematically showing a cross section of the SPDT switch 101A shown in FIGS. 6 to 8. Referring to FIG. 9, the package 10A is formed with electrodes. The pads of the SPST switches 201, 202 are connected to the electrodes of the package 10A. When a signal F_com is inputted into the SPDT switch 101A, the SPDT switch 101A can simultaneously or individually output two signals RF_1, RF_2.

According to this embodiment, the two SPDT switches are configured of the MEMS switches. This makes it possible to achieve improvement in yield rate. In the above configuration, the DPDT switch is configured by combination of the SPDT switches 101, 102. The DPDT switch is configured by combination of two SPDT switches having passed inspection, thereby allowing improvement in yield rate of the DPDT switch.

The yield rate of the DPDT switch configured by combination of two SPDT switches almost agrees with the probability that two contacts of each of the SPDT switches are judged as good. When the DPDT switch is formed on a wafer level, four contacts need to be all judged as good. As opposed to this, in the one SPDT switch, two contacts may only be all judged as good. Therefore, the yield rate of the DPDT switch can be made high as compared to that in the case of forming the DPDT switch on the wafer level.

It is to be noted that FIGS. 3 to 9 show electrostatic drive type MEMS switches. Using the electrostatic drive type MEMS switch can lead to reduction in consumption power of the high-frequency switch. It can further enhance a response speed of the high-frequency switch. However, the MEMS switch is not restricted to the electrostatic drive type. MEMS switches of a variety of driving systems, such as an electromagnetic type actuator, a piezoelectric type actuator and a thermal type actuator, can be adopted.

In the differential transmission, two signals with mutually opposite phases (two signals with a phase difference of 180°) are respectively transmitted on two signal lines. Since magnetic fields that are generated in the respective signal lines are offset, a radiated noise can be made small in the differential transmission. The smaller the space between the two signal lines is made, the more the effect to offset the radiated noise can be enhanced. Accordingly, it is required in the differential transmission to arrange the two signal lines as close to each other as possible.

Further, it is required in the differential transmission that the two signal lines have equal lengths. Assuming that the two signal lines have different lengths, a phase difference of two signals is shifted from 180° during transmission of the signals on the respective signal lines. The shift of the phase difference between the two signals leads to generation of an in-phase component. The in-phase component is removed when a difference between the two signals is generated. This results in reduction in amplitude of a signal obtained from differential signals. Hence it is necessary to make the two signal lines have equal lengths in the differential transmission.

Especially in the high-frequency switch according to this embodiment, for example, differential signals with a frequency of the order of 10 GHz are transmitted. Even when the two signal lines have slightly different lengths (e.g. only by 1 to 2 mm), the phase difference may be significantly shifted from 180°.

In order to satisfy the above requirements, in this embodiment, the two SPDT switches are arranged on the substrate 103 and a pattern of the signal lines is formed on the substrate 103, as described below.

FIG. 10 is a view showing coordinates of the input terminal and the two output terminals of the SPDT switch. It is to be noted that the SPDT switch is flip-chip mounted on the surface of the substrate. Referring to FIG. 10, the center of the SPDT switch 101 is an origin of the SPDT switch 101. An x-axis and a y-axis are two straight lines which pass through the origin of the SPDT switch 101 and are orthogonal to each other.

Using these x-axis and y-axis, coordinates of each of the input terminal and the output terminal of the SPDT switch 101 are expressed by a form of (x, y). It is to be noted that as shown in the above, each of the input terminal and the output terminal is configured of the pad on the signal line, the internal electrode, the through electrode and the external electrode. These coordinates agree with each other. In the following description, the external electrodes 50, 51, 52 exposed to the surface of the SPDT switch 101 are respectively given as an “input terminal 50”, an “output terminal 51”, and an “output terminal 52”.

Coordinates of the input terminal 50 are (x0, y0). Coordinates of the output terminal 52 is (x1, y1). Coordinates of the output terminal 51 are (x2, y2). Here, x1>x0, and x2<x0.

It is to be noted that in the configuration shown in FIGS. 3 to 5, the input terminal 50 is arranged at the origin. The input terminal 50 and the output terminals 51, 52 are arranged on one straight line. A distance between the input terminal 50 and the output terminal 51 is equal to a distance between the input terminal 50 and the output terminal 52. That is, the input terminal 50 and the output terminals 51, 52 are arranged on the x-axis, and relations of: (x0, y0)=(0, 0), x1=−x2, y1=y 2=0, are held. As shown in FIG. 10, for the sake of generalization, the input terminal 50 is at a position different from the origin, and the input terminal 50 and the output terminals 51, 52 are not on one straight line.

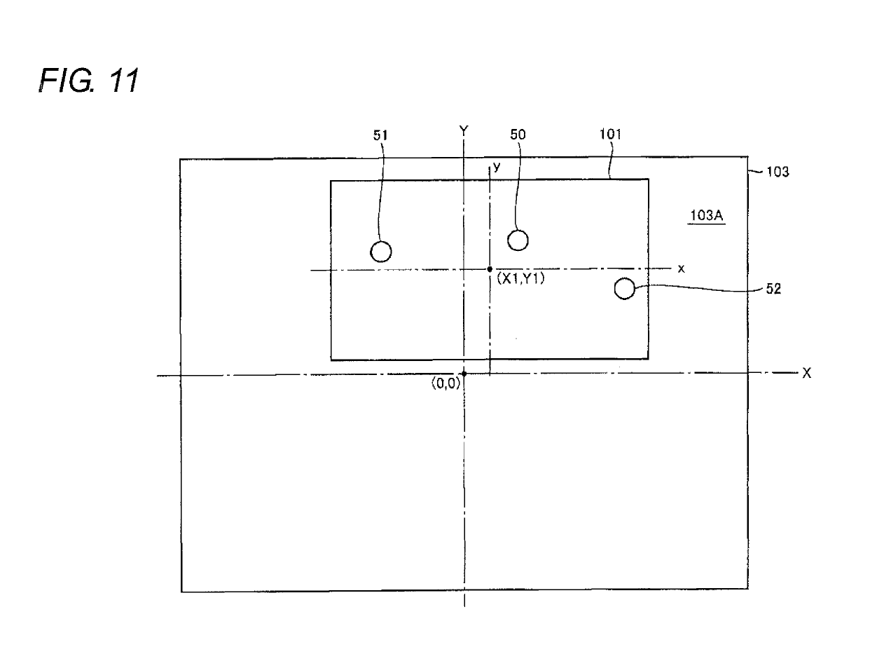

FIG. 11 is a view for explaining coordinates of the SPDT switch with the origin of the principal surface of the substrate 103 taken as a reference. Referring to FIG. 11, the center of the principal surface 103A of the substrate 103 (hereinafter, this principal surface is referred to as “substrate 103”) is taken as the origin of the substrate 103. An X-axis and a Y-axis are two straight lines which pass through the origin of the substrate 103 and are orthogonal to each other. Using these X-axis and Y-axis, coordinates of the origin of the SPDT switch 101 are expressed as (X1, Y1).

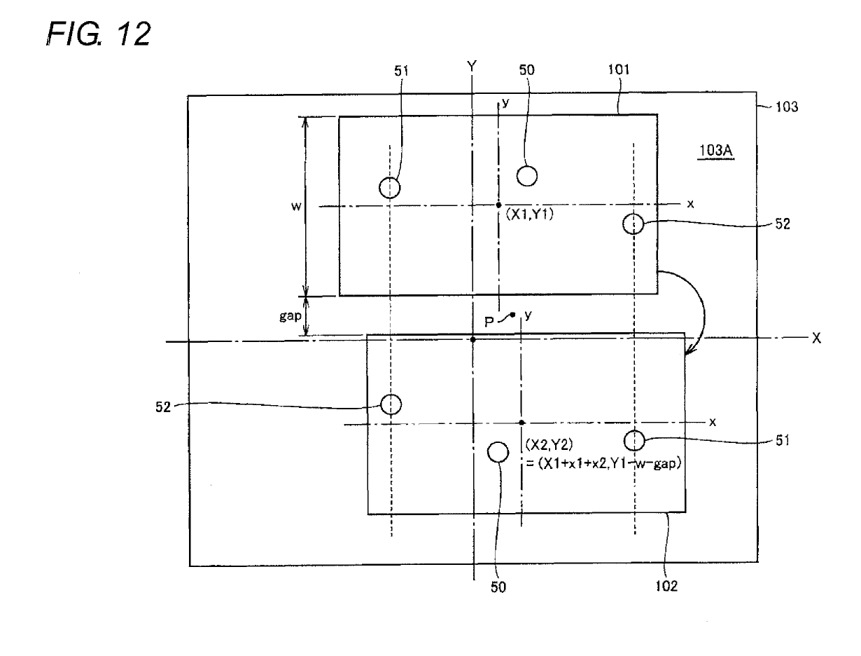

FIG. 12 is a view for explaining coordinates of the two SPDT switches 101, 102 arranged on the principal surface 103A of the substrate 103. Referring to FIG. 12, the SPDT switches 101, 102 satisfy the relation of twofold rotational symmetry with respect to a point P. That is, when the SPDT switch 101 is rotated by 180° around the point P, the SPOT switch 101 and the SPDT switch 102 overlap each other.

Coordinates of the origin of the SPDT switch 101 with the origin of the substrate 103 taken as the reference are expressed as (X1, Y1). In the same manner, coordinates of the origin of the SPDT switch 102 with the origin of the substrate 103 taken as the reference are expressed as (X2, Y2). In this embodiment, the SPDT switches 101, 102 are arranged such that the output terminal 51 of the SPOT switch 101 and the output terminal 52 of the SPOT switch 102 are on the same axis and the output terminal 52 of the SPDT switch 101 and the output terminal 51 of the SPDT switch 102 are on the same axis. In this description, the “same axis” means the same X-coordinate.

An X-coordinate of the output terminal 51 of the SPDT switch 101 is (X1+x1). Meanwhile, an X-coordinate of the output terminal 52 of the SPDT switch 102 is (X2−x2). As described above, x1 is an x-coordinate of the output terminal 51 of the SPDT switch 101, and x2 is an x-coordinate of the output terminal 52 of the SPDT switch 101. Since the X-coordinate of the output terminal 51 of the SPDT switch 101 is equal to the X-coordinate of the output terminal 52 of the SPDT switch 102, the relation: X1+x1=X2−x2 is held. Therefore, X2=X1+x1+x2 is held.

Meanwhile, a Y-axial length of the SPDT switch 101 is referred to as a width w. A space between the SPDT switch 101 and the SPDT switch 102 is referred to as a gap. The relation: Y2=Y1−w−gap, is held between Y1 and Y2. Therefore, the relation is expressed as: (X2, Y2)=(X1+x1+x2, Y1−w−gap).

The principal surface 103A of the substrate 103 is formed with pads (a total of 6 pads) connected to the respective input terminals 50 and output terminals 51, 52 of the SPOT switches 101, 102. The substrate 103 is further connected with signal lines connected to the pads.

That is, the output terminal 51 of the SPDT switch 101 and the output terminal 52 of the SPDT switch 102 are placed side by side along a direction in which the SPDT switches 101, 102 are arranged. Accordingly, as described below, two output signal lines respectively connected to the output terminal 51 of the SPDT switch 101 and the output terminal 52 of the SPDT switch 102 can be made to have equal lengths. Further, the two output signal lines can also be arranged as close to each other as possible.

In the same manner, the output terminal 52 of the SPDT switch 101 and the output terminal 51 of the SPDT switch 102 are placed side by side along the direction in which the SPDT switches 101, 102 are arranged. Accordingly, two output signals respectively connected to the output terminal 52 of the SPDT switch 101 and the output terminal 51 of the SPDT switch 102 can be made to have equal lengths. Further, the two output signal lines can also be arranged as close to each other as possible.

As thus described, since the two output signal lines can be made to have equal lengths and the two output signal lines can be arranged as close to each other as possible, differential signals can be transmitted by the two signal lines. Further, it is possible to reduce loss attributed to mode transition in transmission of differential signals. Therefore, according to this embodiment, it is possible to realize a high-frequency switch suitable for differential signals.

Further, according to the above configuration, it is possible to perform wiring with ease, so as to increase an effective package density of the substrate. For example, a device having multiple channels (which is not restricted to this example, but is a semiconductor detector, for example) is required to have a large number of switches. A mounting area of the switch also includes signal lines necessary for effective input into and output from the switches. According to this embodiment, by realizing simple wiring, the mounting area of the switch can be reduced. Hence it is possible to increase an effective package density.

Another terminal may exist between the output terminal 51 of the SPDT switch 101 and the output terminal 52 of the SPDT switch 102. However, according to one or more embodiments of the present invention, these output terminals are arranged as close to each other as possible. In one or more embodiments of the present invention, the output terminal 51 of the SPDT switch 101 and the output terminal 52 of the SPDT switch 102 are placed side by side. In this case, another terminal does not exist between the two output terminals. Since arrangement between the output terminal 52 of the SPOT switch 101 and the output terminal 51 of the SPDT switch 102 is similar to the above, the description of such an arrangement will not be repeated hereinafter.

Further, according to the above configuration, it is possible to perform wiring with ease, so as to increase an effective package density of the substrate. A mounting area of the switch also includes signal lines necessary for effective input into and output from the switch. Simplification of the wiring can lead to reduction in mounting area of the switch, thereby to increase in effective package density of the substrate.

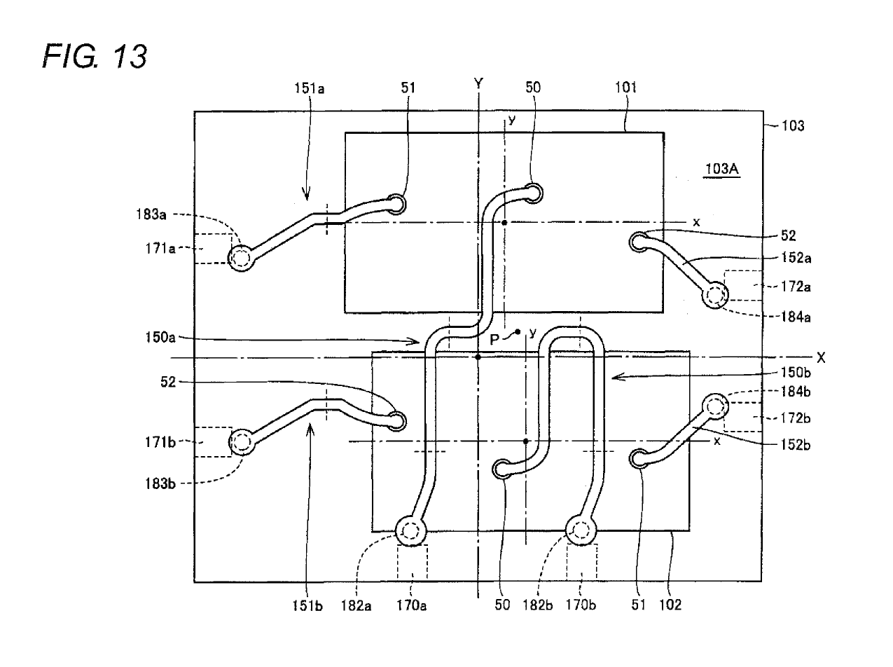

FIG. 13 is a view showing one embodiment of a signal line pattern formed on the substrate 103. Referring to FIG. 13, the principal surface 103A of the substrate 103 is formed with input signal lines 150a, 150b, output signal lines 151a, 151b, and output signal lines 152a, 152b.

The input signal lines 150a, 150b constitute an input signal line pair for inputting differential signals into the SPDT switches 101, 102. The output signal lines 151a, 151b constitute a first output signal line pair for outputting differential signals from the SPDT switches 101, 102. The output signal lines 152a, 152b constitute a second output signal line pair for outputting differential signals from the SPDT switches 101, 102. Each of the input signal line pair and the first and second output signal line pairs has symmetry. It is to be noted that the “symmetry” includes rotational symmetry (n-fold rotational symmetry), mirror symmetry, translational symmetry and an arbitrary combination thereof.

When the signal line is in a uniform shape, the signal is not reflected. However, reflection occurs in a section of the signal line where a wire shape (sectional shape) thereof changes, such as a bent section or a section where a line width changes. It is assumed, for example, that each of the two signal lines constituting the signal line pair has two reflection points. When a distance between the two reflection points differs between the two signal lines constituting the signal line pair, waveforms of the signals that have repeated reflection differ from each other. For this reason, when a difference between the signals respectively transmitted on the two signal lines is taken, loss is generated. According to this configuration, the symmetry exists between the two signal lines.

Pads 170a, 170b, 171a, 171b, 172a, 172b are formed on the principal surface 103B (cf. FIG. 2) on the opposite side to the principal surface 103A. Vias 182a, 182b, 183a, 183b, 184a, 184b penetrate the substrate 103. The input signal lines 150a, 150b are connected to the pads 170a, 170b through the vias 182a, 182b. The output signal lines 151a, 151b are connected to the pads 171a, 171b respectively through the vias 183a, 183b. The output signal lines 152a, 152b are connected to the pads 172a, 172b respectively through the vias 184a, 184b.

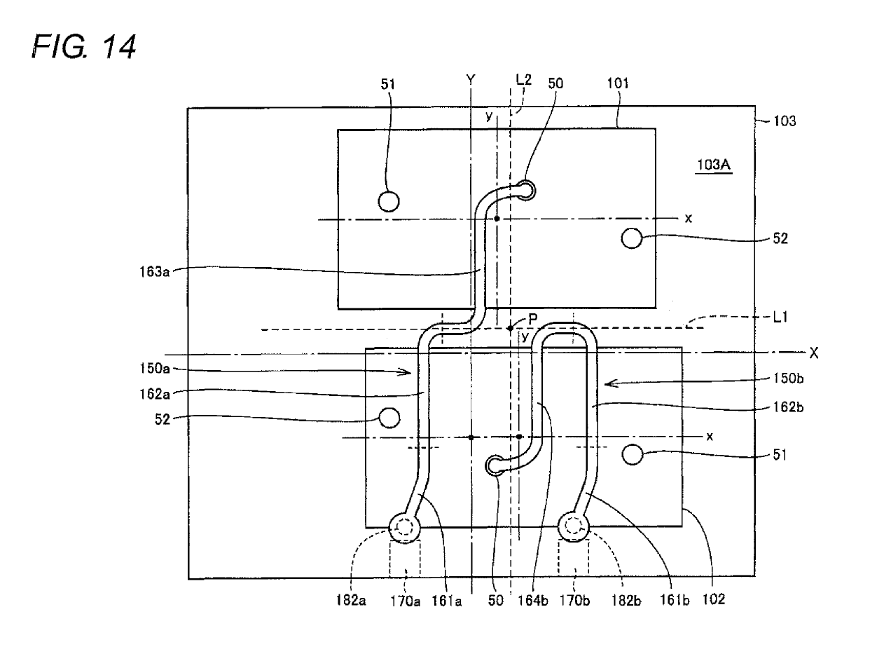

Next, the symmetry of each signal line pair will be specifically described. FIG. 14 is a view for explaining the symmetry of input signal lines 150a, 150b. Referring to FIG. 14, the input signal line 150a has wiring portions 161a, 162a, 163a. The input signal line 150b has wiring portions 161b, 162b, 163b.

The wiring portions 161a, 161b have translational symmetry. That is, when the wiring portion 161a is virtually moved in an X-axis direction, the wiring portion 161a overlaps the wiring portion 161b. By the input signal line pair having such translational symmetry portions, it is possible to arbitrarily set X-axial positions of the two input pads (pads 170a, 170b) on the lower surface (principal surface 103B) of the substrate 103. It is thereby possible to enhance the degree of freedom in layout of the input pads.

The wiring portions 162a, 162b are in the relation of mirror symmetry with respect to a straight line L2. By the input signal line pair having such mirror symmetry portions, it is possible to arbitrarily set a pitch of the two input pads (an X-axial space between the pads 170a, 170b). It is thereby possible to enhance the degree of freedom in layout of the input pads.

The wiring portions 163a, 163b have rotational symmetry. That is, when the wiring portion 163a is virtually rotated by 180° around the point P, the wiring portion 163a overlaps the wiring portion 163b. The point P is an intersection point of the straight line L1 and the straight line L2. The straight line L1 is a straight line located at an equal distance from each of the SPDT switches 101, 102. The straight line L2 is a straight line located at an equal distance from each of the y-axis of the SPDT switch 101 and the y-axis of the SPOT switch 102. In addition, hereinafter, the straight line L1 is also referred to as a “median”.

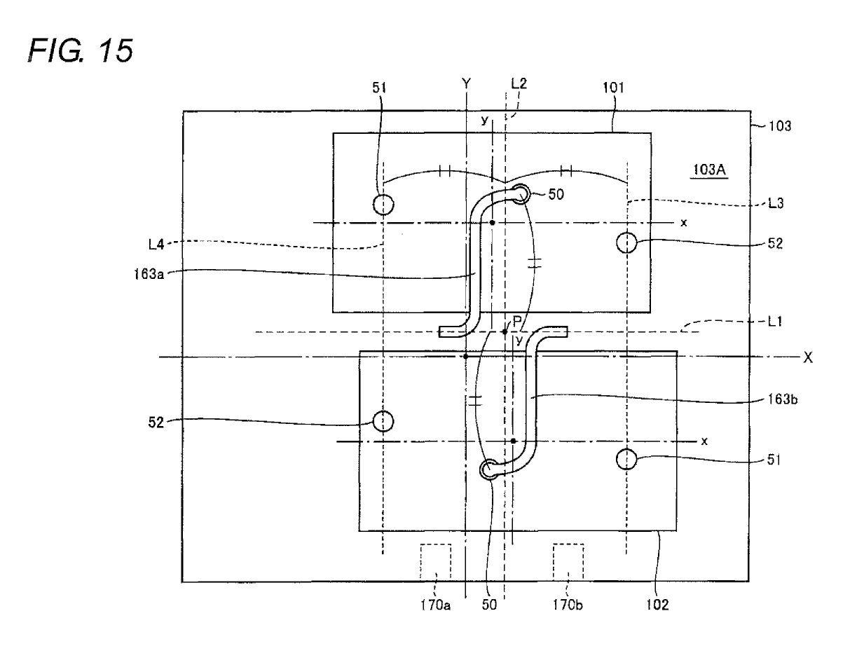

FIG. 15 is a view for explaining, in detail, rotational symmetry portions (wiring portions 163a, 163b) of the input signal line pair shown in FIG. 14. Referring to FIG. 15, the wiring portion 163a is a portion of the SPDT 101 from the input terminal 50 to the median (straight line L1). The wiring portion 163b is a portion of the SPDT 102 from the external electrode 50 to the median.

Since the wiring portions 163a, 163b are in the relation of rotational symmetry, the wiring portions 163a, 163b have equal lengths. Further, a distance of the SPDT 101 from the input terminal 50 to the median is equal to a distance of the SPOT 102 from the input terminal 50 to the median. The SPOT switches 101, 102 are arranged at different distances from the input pads 170a, 170b. An output signal line pair having equal lengths and high symmetry can be realized by the wiring portions 163a, 163b (rotational symmetry wiring portions). Accordingly, it is possible to reduce loss attributed to mode transition in transmission of differential signals.

A straight line connecting the output terminal 52 of the SPDT switch 101 with the output terminal 51 of the SPDT switch 102 is referred to as L3, and a straight line connecting the output terminal 51 of the SPDT switch 101 with the output terminal 52 of the SPDT switch 102 is referred to as L4. The straight lines L3, L4 are parallel to the straight line L2. Further, a distance from the straight line L3 to the straight line L2 is equal to a distance from the straight line L4 to the straight line L2.

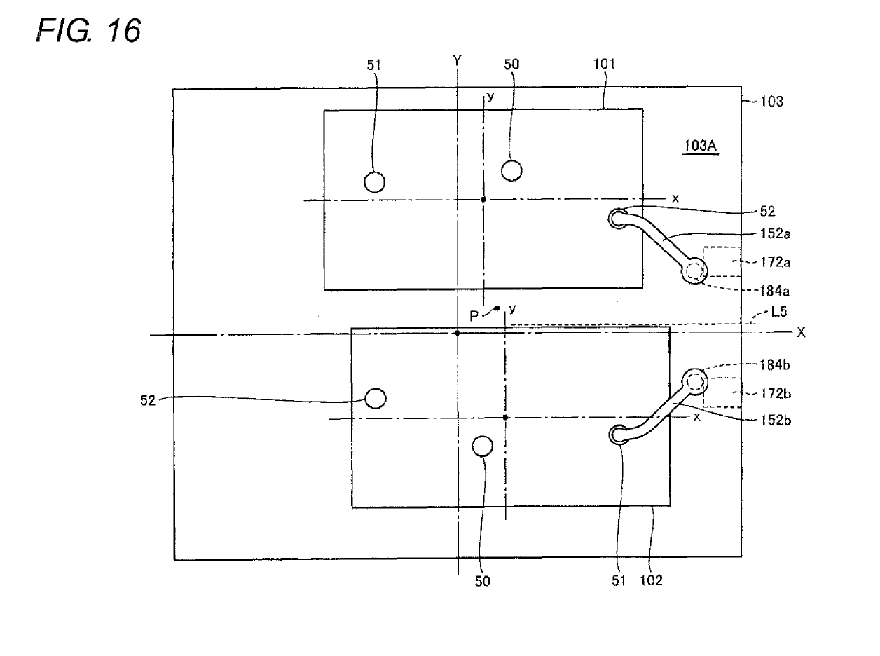

FIG. 16 is a view for explaining symmetry of the output signal line pair (output signal lines 152a, 152b) shown in FIG. 14. Referring to FIG. 16, the output signal lines 152a, 152b are in the relation of mirror symmetry with respect a straight line L5. The straight line L5 is a straight line which passes through the median point between the output terminal 52 of the SPDT switch 101 and the output terminal 51 of the SPDT switch 102 and is parallel to the X-axis. By the output signal lines 152a, 152b being in the relation of mirror symmetry, it is possible to arbitrarily adjust a Y-axial pitch of the pads 172a, 172b. It is thereby possible to enhance the degree of freedom in layout of the output pads.

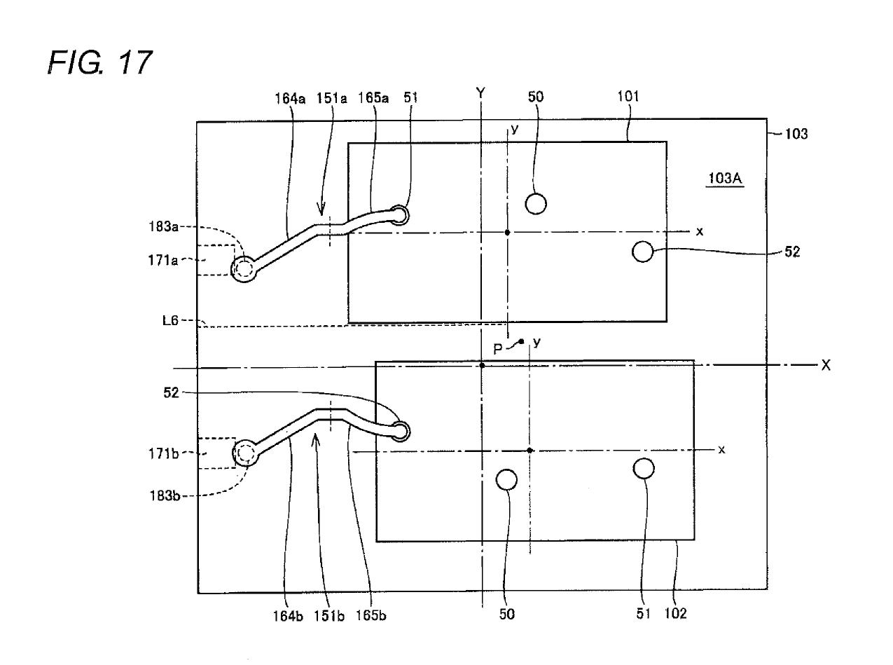

FIG. 17 is a view for explaining symmetry of the other output signal line pair (output signal lines 151a, 151b) shown in FIG. 14. Referring to FIG. 17, the output signal line 151a is provided with wiring portions 164a, 165a. The output signal line 151b is provided with wiring portions 164b, 165b. The wiring portions 164a, 164b have translational symmetry along the Y-axis direction. On the other hand, the wiring portions 165a, 165b are in the relation of mirror symmetry with respect a straight line L6. The straight line L6 is a straight line which passes through the median point between the output terminal 51 of the SPDT switch 101 and the output terminal 52 of the SPDT switch 102 and is parallel to the X-axis. By the wiring portions 165a, 165b being in the relation of mirror symmetry, it is possible to arbitrarily adjust a Y-axial pitch of the pads 171a, 171b. Further, by the wiring portions 164a, 164b having translational symmetry, it is possible to arbitrarily adjust a Y-axial position of the pads 171a, 171b. It is thereby possible to enhance the degree of freedom in layout of the output pads.

In addition, the configuration of the one output signal line pair only having mirror symmetry and the other output signal line pair having mirror symmetry and translational symmetry is not restrictive. For example, both output signal line pairs may only have mirror symmetry, or may have both mirror symmetry and translational symmetry. Further, the output signal line pair made up of the output signal lines 152a, 152b may have both mirror symmetry and translational symmetry, and the output signal line pair made up of the output signal lines 151a, 151b may only have mirror symmetry.

On the other hand, when two signal lines are arranged without consideration of such symmetry as described above, it is difficult to realize isometric wiring, for example. A reason for this will be described below.

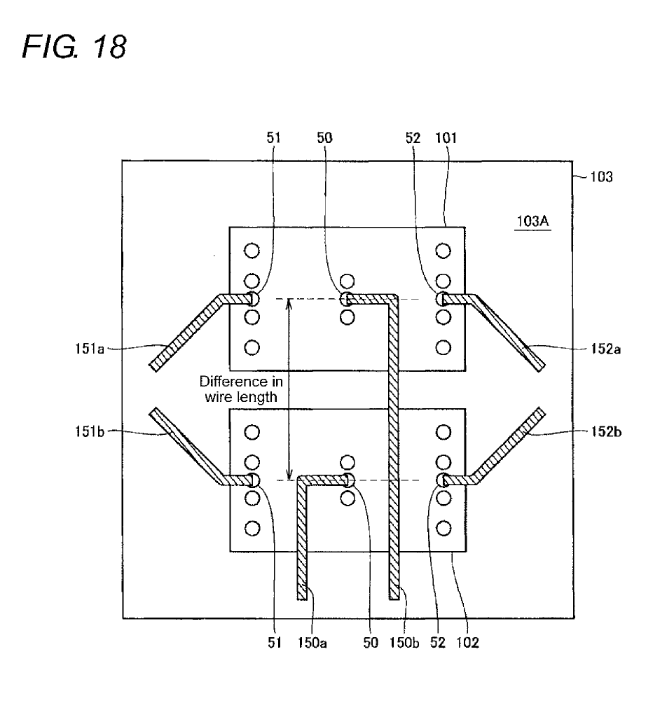

FIG. 18 is a view showing an example of a wiring pattern in the state where respective two signal lines constituting the signal line pairs are extracted along the surface in the shortest manner. Referring to FIG. 18, each signal line is extracted from the terminal of the SPDT switch 101 or 102 to the edge of the substrate 103 along the surface thereof. This is because the pads of the substrate 103 are arranged at the edges of the substrate 103.

The output signal line pair made up of the output signal lines 151a, 151b and the output signal line pair made up of the output signal lines 152a, 152b can realize isometric wiring even when being extracted to the edges of the substrate 103 along the surface thereof at the shortest distances. This is because the output signal lines 151a, 151b have mirror symmetry and the output signal lines 152a, 152b also have mirror symmetry. However, when each of the input signal lines 150a, 150b is extracted to the edge of the substrate 103 along the surface thereof at the shortest distance, the input signal lines 150a, 150b have different lengths. In this case, mode transition may occur.

As thus described the input signal line pair and the two output signal line pairs are each configured of the two signal lines having symmetry. Hence each signal line pair can realize isometric wiring, and the two signal lines can be arranged adjacent to each other. Therefore, according to this embodiment, it is possible to realize a high-frequency switch suitable for differential transmission.

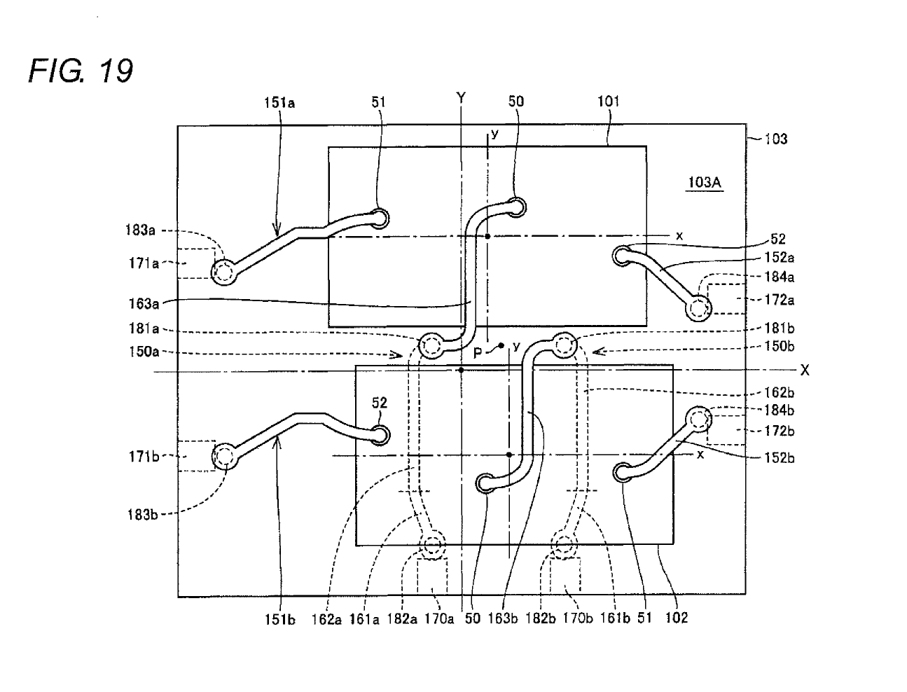

FIG. 19 is a view showing another example of wiring according to one or more embodiments of the present invention. Referring to FIG. 19, the wiring portions 161a, 162a out of the input signal line 150a are formed in a wiring layer different from the principal surface 103A. The wiring portion 163a is connected to the wiring portions 161a, 162a by the via 181a. The wiring portions 161a, 162a are connected to the pad 170a by the via 182a. The configuration of the input signal line 150b is similar to the configuration of the input signal line 150a, and the vias 181b, 182b are used in place of the vias 181a, 182a.

The wiring portions 161a, 162a are integrally formed. In the same manner, the wiring portions 161b, 162b are integrally formed. The wiring portions 161a, 162a, 161b, 162b are formed in the wiring layer between the principal surface 103A and the principal surface 103B. As thus described, part of each signal wiring may be formed in a different wiring layer, and that part of the wiring may be connected with the remaining wiring by vias. Next, specific constitutional examples of the DPDT switch according to one or more embodiments of the present invention will be described.

### Embodiment 1

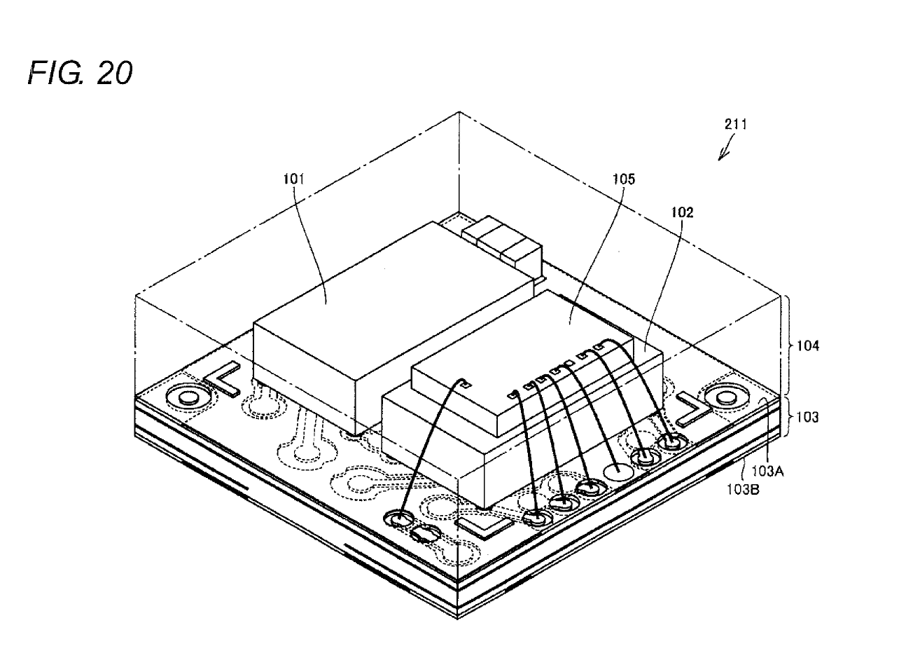

FIG. 20 is an internal perspective view of a high-frequency switch according to Embodiment 1. Referring to FIG. 20, a high-frequency switch 211 according to Embodiment 1 is provided with the SPDT switches 101, 102, the substrate 103, and the sealing member 104. The high-frequency switch 211 further includes an ASIC (Application Specific Integrated Circuit) 105. The ASIC 105 is arranged on the SPDT switch 102, and sealed by the sealing member 104 along with the SPDT switches 101, 102. The ASIC 105 is connected to the electrodes of the substrate 103 by bonding wires. Further, the electrodes of the SPDT switches 101, 102 are connected to the electrodes of the substrate 103 by soldering, not shown. It is to be noted that the SPDT switches 101, 102 are fixed to the principal surface 103A of the substrate 103 by under filling (not shown), for example. The high-frequency switch 211 may include a passive element such as a capacitor in addition to or in place of an active element such as the ASIC 105. Such an active element and/or passive element are mounted on the principal surface 103A of the substrate 103 and sealed by the sealing member 104.

By such a configuration, it is possible to enhance a function or performance of the high-frequency switch. For example, the SPDT switches 101, 102 can be controlled (e.g., voltages can be supplied to the SPOT switches 101, 102) by the active element such as the ASIC 105. This may eliminate the need for preparing additional configuration for the high-frequency switch, such as a voltage supply source. Further, a filter can be formed by the passive element such as the capacitor, for example, so as to facilitate adjustment of characteristics.

The substrate 103 is a multi-layer substrate. The signal line is formed using a metal pattern formed in a wiring layer of the substrate 103 and a through electrode (via) electrically connecting the metal pattern of each wiring layer.

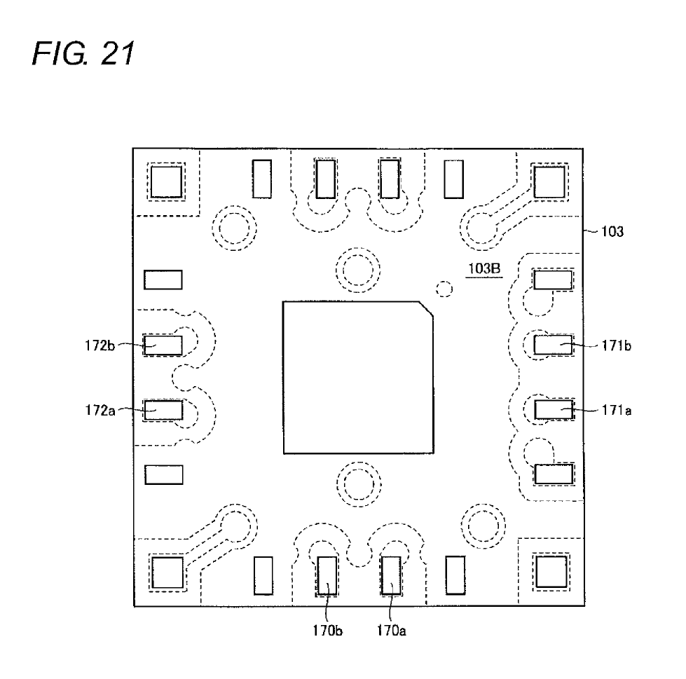

FIG. 21 is a view showing arrangement of pads on the lower surface of the substrate 103. Referring to FIG. 21, the “lower surface of the substrate” corresponds to the principal surface 103B of the substrate 103 shown in FIG. 1. The principal surface of the substrate 103 is formed with the pads 170a, 170b, 171a, 171b, 172a, 172b. Two pads corresponding to the signal Line pair are arranged adjacent to each other. Specifically, the pads 170a, 170b are pads connected to the input signal line pair, and arranged adjacent to each other. The pads 171a, 171b are pads corresponding to the output signal line pair, and arranged adjacent to each other. The pads 172a, 172b are pads corresponding to another output signal line pair, and arranged adjacent to each other.

As thus described, components mounted on the principal surface 103A of the substrate 103 (the components include the SPDT switches 101, 102 and the ASIC 105; another component may be mounted on the principal surface 103A) can be protected by the sealing member 104 from the outside, so as to enhance the reliability of the high-frequency switch 211. Meanwhile, with the sealing member 104 being arranged on the principal surface 103A of the substrate 103, the input pads (pads 170a, 170b) and the output pads (pads 171a, 171b and pads 172a, 172b) are arranged on the principal surface 103B located on the opposite side to the principal surface 103A. By arranging the input signal lines 150a, 150b as close to each other as possible on the principal surface 103A, the two input pads (pads 170a, 170b) can be arranged as close to each other as possible on the principal surface 103B. Moreover, by arranging the output signal lines 151a, 151b as close to each other as possible on the principal surface 103A, the two output pads (pads 171a, 171b) can be arranged as close to each other. In the same manner, by arranging the output signal lines 152a, 152b as close to each other as possible on the principal surface 103A, the two output pads (pads 172a, 172b) can be arranged as close to each other.

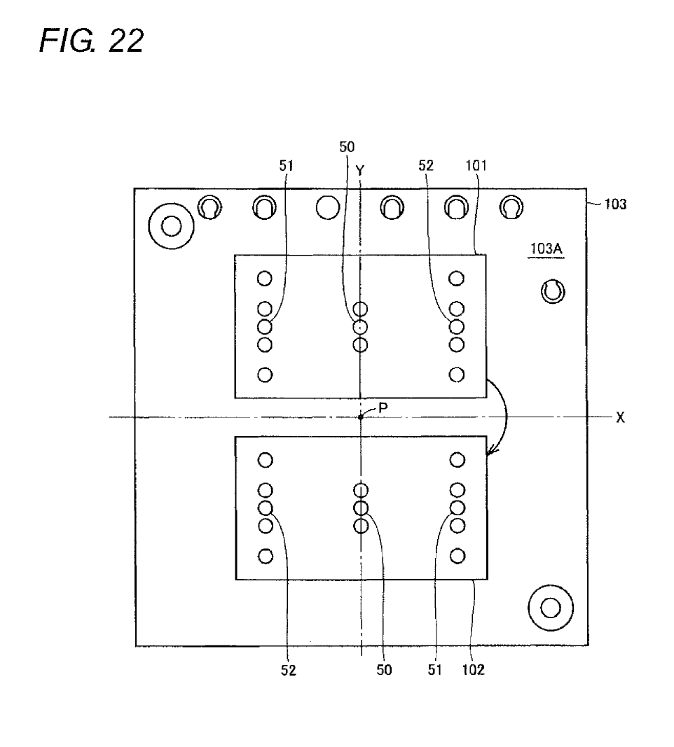

FIG. 22 is a view for explaining arrangement of the two SPDT switches on the substrate. Referring to FIG. 22, the point P corresponds to an intersection point of the X-axis and Y-axis. In this example, the point P corresponds to the center (origin) of the substrate 103. The SPDT switches 101, 102 are arranged with twofold rotational symmetry with respect to the point P on the principal surface 103A of the substrate 103. Accordingly, the output terminal 51 of the SPDT switch 101 and the output terminal 52 of the SPDT switch 102 are located on the same side with respect to the Y-axis (the left side of the Y-axis in the figure), and on the opposite side to each other across the X-axis. Similarly, the output terminal 52 of the SPDT switch 101 and the output terminal 51 of the SPDT switch 102 are located on the same side with respect to the Y-axis (the right side of Y-axis in the figure), and on the opposite side to each other across the X-axis.

Further, in this embodiment, the y-axis of each of the SPDT switches 101, 102 agrees with the Y-axis of the substrate 103. Hence the output terminal 51 of the SPOT switch 101 and the output terminal 52 of the SPOT switch 102 are adjacent to each other across the X-axis. Similarly, the output terminal 52 of the SPDT switch 101 and the output terminal 51 of the SPDT switch 102 are adjacent to each other across the X-axis. Accordingly, the two signal lines constituting the output signal line pair can be made to have equal lengths.

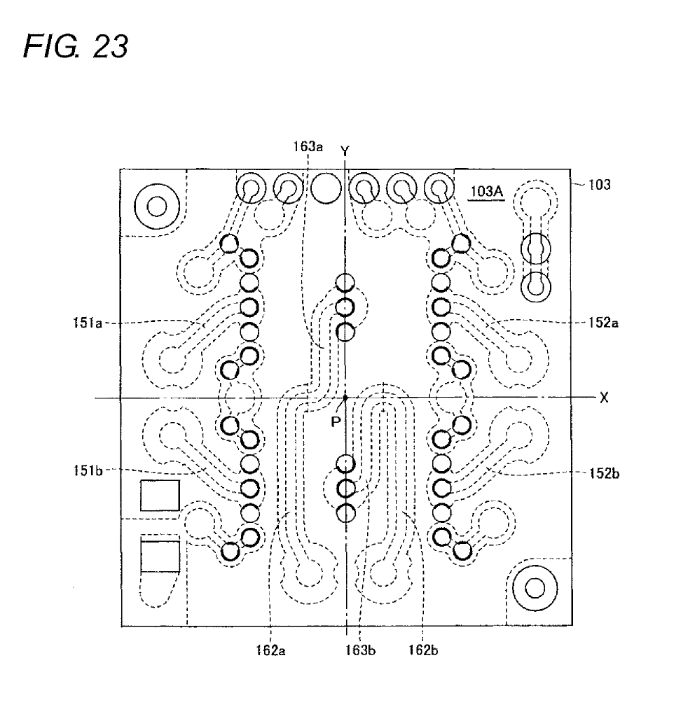

FIG. 23 is a view for explaining arrangement of the signal line pairs. Referring to FIG. 23, the input signal lines 150a, 150b have a shape in combination of mirror symmetry and rotational symmetry. Specifically, the wiring portions 162a, 162b are in the relation of mirror symmetry. The wiring portions 163a, 163b are in the relation of the twofold rotational symmetry with respect to the point P. By the wiring portions 163a, 163b being in the relation of rotational symmetry, it is possible to realize an input signal line pair having equal lengths and high symmetry. Accordingly, it is possible to reduce loss attributed to mode transition in transmission of differential signals. By the wiring portions 162a, 162b being in the relation of mirror symmetry, it is possible to arbitrarily set a distance between the corresponding input pad pair (input pads 170a, 170b of FIG. 21).

On the other hand, the output signal lines 151a, 151b are in the relation of mirror symmetry with respect to the X-axis. In the same manner, the output signal lines 152a, 152b are in the relation of mirror symmetry with respect to the X-axis. By the respective two output signal lines as the output signal line pairs being in the relation of mirror symmetry, it is possible to arbitrarily set distances between pad pairs (output pads 171a, 171b and output pads 172a, 172b of FIG. 21) corresponding to the output signal line pairs.

As thus described, by the input signal line pair and the output signal line pairs each having symmetry, the two signal lines constituting each signal line pair can be made to have equal lengths, and the signal lines can also be arranged adjacent to each other. Therefore, according to Embodiment 1, it is possible to realize a high-frequency switch suitable for differential transmission.

### Embodiment 2

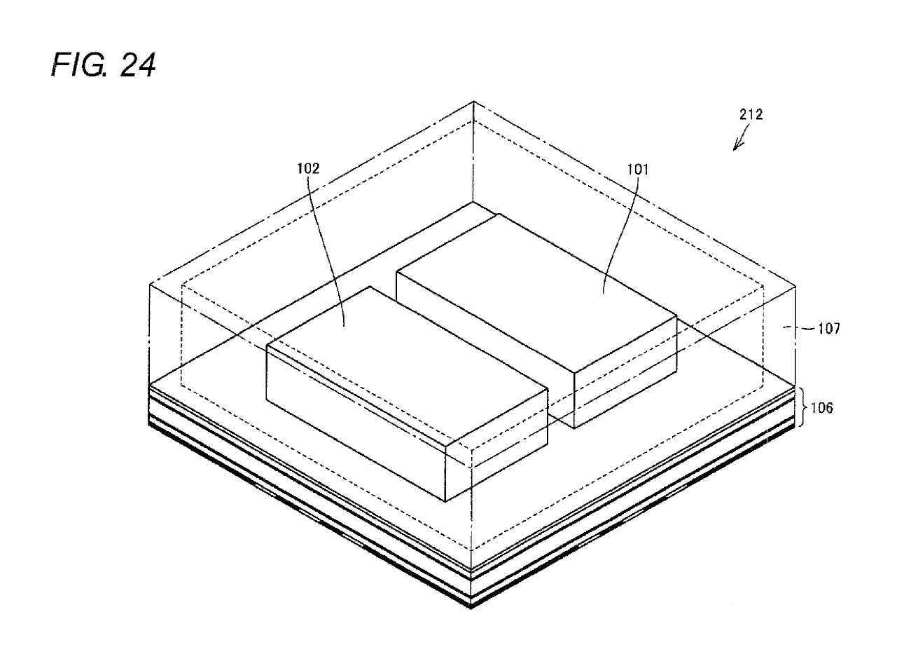

FIG. 24 is an internal perspective view of a high-frequency switch according to Embodiment 2. Referring to FIG. 24, a high-frequency switch 212 according to Embodiment 2 is different from the high-frequency switch 211 according to Embodiment 1 in including a substrate 106 in place of the substrate 103. The high-frequency switch 212 is different from the high-frequency switch 211 in including a sealing member 107 in place of the sealing member 104. In Embodiment 2, a buildup substrate is adopted as the substrate 106. Further, a cap is adopted as the sealing member 107.

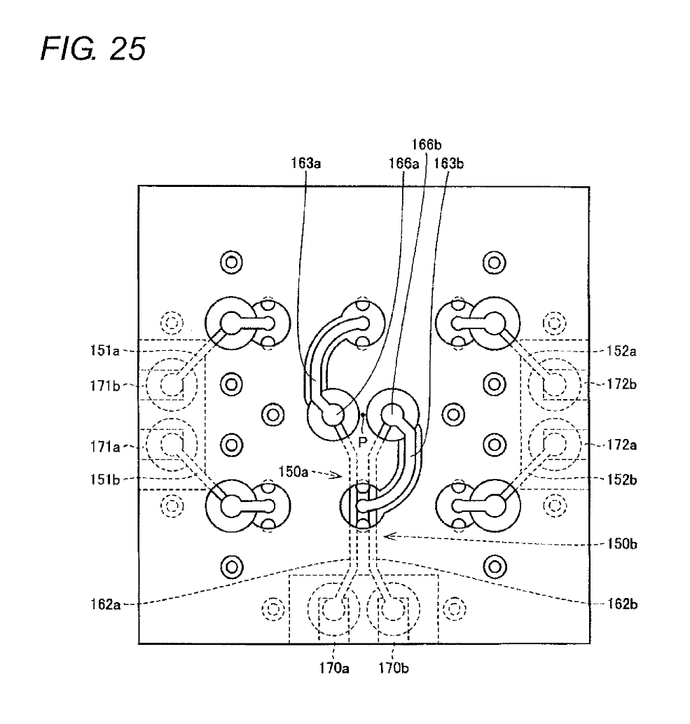

FIG. 25 is a plan transparent view for explaining a signal line formed on the substrate 106 shown in FIG. 24. Referring to FIG. 25, the input signal line 150a has wiring portions 162a, 163a formed in different wiring layers. The wiring portions 162a, 163a are connected by a via 166a. In the same manner, the input signal line 150b has wiring portions 162b, 163b formed in the different wiring layers. The wiring portions 162b, 163b are connected by a via 166b.

The wiring portions 162a, 162b are in the relation of mirror symmetry. The wiring portions 163a, 163b are in the relation of rotational symmetry. That is, the symmetry of the input signal lines 150a, 150b is switched from mirror symmetry to rotational symmetry by the vias 166a, 166b. As in Embodiment 1, by the wiring portions 163a, 163b being in the relation of rotational symmetry, it is possible to realize an input signal line pair having equal lengths and high symmetry. Accordingly, it is possible to reduce loss attributed to mode transition in transmission of differential signals. Further, by the wiring portions 162a, 162b being in the relation of mirror symmetry, it is possible to arbitrarily set a distance between the corresponding input pad pair (input pads 170a, 170b of FIG. 25).

It is to be noted that the output signal lines 151a, 151b are in the relation of mirror symmetry. In the same manner, the output signal lines 152a, 152b are in the relation of mirror symmetry. By the respective two output signal lines as the output signal line pairs being in the relation of mirror symmetry, it is possible to arbitrarily set distances between pad pairs (output pads 171a, 171b and output pads 172a, 172b of FIG. 25) corresponding to the output signal line pairs.

As thus described, according to Embodiment 2, by the input signal line pair and the output signal line pairs each having symmetry, the two signal lines constituting each signal line pair can be made to have equal lengths, and the signal lines can also be arranged adjacent to each other. Therefore, according to Embodiment 2, it is possible to realize a high-frequency switch suitable for differential transmission.

The embodiments disclosed herein should be considered as not restrictive but illustrative in all aspects. The scope of the present invention is shown not by the above descriptions but by the claims, and is intended to include all alternations within the meaning and range equivalent to the claims. While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A high-frequency switch configured to transmit differential signals including first and second signals, the high-frequency switch comprising:
first and second switches each comprising an input terminal configured to receive a signal and two output terminals configured to output the signal; and
a substrate comprising a first surface mounted with the first and second switches, wherein
the input terminal is arranged between the two output terminals,
the first and second switches are arranged on the substrate along a direction intersecting with a direction in which the input terminal and the two output terminals are placed side by side,
one terminal of the first switch and one terminal of the second switch are placed side by side along the direction in which the first and second switches are arranged, and
another terminal of the first switch and another terminal of the second switch are placed side by side along the direction in which the first and second switches are arranged.

2. The high-frequency switch according to claim 1, wherein
the substrate comprises
first and second input signal lines respectively connected to the input terminal of the first switch and the input terminal of the second switch,
first and second output signal lines respectively connected to one terminal of the two output terminals of the first switch and one terminal of the two output terminals of the second switch, and
third and fourth output signal lines respectively connected to another terminal of the two output terminals of the first switch and another terminal of the two output terminals of the second switch,
the first and second input signal lines constitute a first signal line pair configured to transmit the differential signals,
the first and second output signal lines constitute a second signal line pair configured to transmit the differential signals,
the third and fourth output signal lines constitute a third signal line pair configured to transmit the differential signals, and
each of the first, second or third signal line pairs has at least one of rotational symmetry, mirror symmetry and translational symmetry.

3. The high-frequency switch according to claim 2, wherein
the first signal line pair comprises
first wiring portions arranged with twofold rotational symmetry, and
second wiring portions arranged with mirror symmetry with respect to the direction in which the first and second switches are arranged.

4. The high-frequency switch according to claim 3, wherein
the first signal line pair further comprises
third wiring portions arranged with translational symmetry with respect to the direction in which the input terminal and the two output terminals are placed side by side.

5. The high-frequency switch according to claim 2, wherein
each of the second and third signal line pairs is arranged so as to satisfy at least one of mirror symmetry with respect to the direction in which the input terminal and the two output terminals are placed side by side and translational symmetry with respect to the direction in which the first and second switches are arranged.

6. The high-frequency switch according to claim 2, further comprising
a sealing member arranged on the first surface of the substrate and configured to seal the first and second switches, wherein
the substrate comprises
a second surface located on the opposite side to the first surface,
first and second input pads arranged adjacent to each other on the second surface and electrically connected respectively to the first and second input signal lines,
first and second output pads arranged adjacent to each other on the second surface and electrically connected respectively to the first and second output signal lines, and
third and fourth output pads arranged adjacent to each other on the second surface and electrically connected respectively to the third and fourth output signal lines.

7. The high-frequency switch according to claim 1, wherein
the first and second switches are MEMS (Micro Electro Mechanical Systems) switches.

8. The high-frequency switch according to claim 7, wherein
the MEMS switch is an electrostatic drive type MEMS switch.

9. The high-frequency switch according to claim 1, wherein
the two output terminals of each of the first and second switches are arranged with symmetry with respect to the input terminal.

10. The high-frequency switch according to claim 1, further comprising
at least one of a passive element and an active element mounted on the first surface of the substrate along with the first and second switches.
